(19) United States
(12) Patent Application Publication
(10) Pub. No.: US 2010/0002420 A1
(43) Pub. Date: Jan. 7, 2010

(54) Backlight Module and Back Plate and Base Thereof

(75) Inventor: Chin-Ting Shih, Hsin-Chu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORPORATION, Hsin-Chu (TW)

(21) Appl. No.: 12/423,131

(22) Filed: Apr. 14, 2009

(30) Foreign Application Priority Data
Jul. 2, 2008 (TW) 97124978

(51) Int. Cl. G02F 1/13357; F21V 19/00

(52) U.S. Cl. 362/97.2; 362/382

(57) ABSTRACT

A backlight module includes a back plate, a frame, a lamp set, and a lamp rack. The back plate has an inner surface to serve as a light reflecting surface. Besides, two corresponding sides of the back plate respectively include a sidewall structure including a connecting groove. The connecting groove receives the frame to form a frame with a concave center portion. By integrating the back plate and the frame into the backlight module base has an advantage in saving material and cost.

This application claims benefit to a Taiwanese Patent Application No. 097124978, filed on Jul. 2, 2008, the disclosure of which is incorporated herein by reference in its entirety.

### BACKGROUND OF THE INVENTION

1. Field of the Invention

The present invention relates to a backlight module for a liquid crystal display. Particularly, the present invention relates to a backlight module having an integral back plate.

2. Description of the Prior Art

As the demand for flat panel displays increases, the development of the backlight module becomes more and more important. With reference to FIG. 1, a conventional backlight module 10 is composed of an iron plate 20, a lamp set 50, a lamp holder 60, lamp racks 70, a reflector 30, and a plastic frame 40. The conventional backlight module requires a huge amount of manpower and time to assemble a lot of required components. Especially in the area of higher labor cost, the conventional backlight module is less competitive in price. Besides, the conventional backlight module usually requires the reflector 30 to reflect light so as to enhance the illumination efficiency. However, the reflector 30 not only requires more space to be disposed but also increases the production cost, and in turns reduces the attractiveness in the market.

Because the conventional backlight module has so many components requiring lots of manpower to assemble. Thus, the labor cost becomes a major disadvantage in manufacture. In view of the drawbacks of the conventional backlight module, it is desired to provide a backlight module with fewer components to simplify the assembly process.

### SUMMARY OF THE INVENTION

It is an object of the present invention to provide a backlight module capable of reducing required materials but still maintaining similar function to reduce the production cost.

It is another object of the present invention to provide a backlight module having an integral back-frame combing the functions of the traditional iron plate and the plastic frame.

It is a further object of the present invention to provide a backlight module integrating the reflector and the plastic frame so as to reduce the number of components and the labor cost for assembly.

A backlight module includes a back plate, a frame, a lamp set, and a lamp rack. The back plate has an inner surface, which can serve as a light reflecting surface. Two sidewall structures are formed on two opposite sides of the back plate, respectively. Each of the sidewall structures is bent to form a connecting groove. Each of the connecting grooves has an opening, respectively. Each opening direction of the openings is opposite to the inner surface. In other words, the opening of the connecting groove is on the back side with respect to the inner surface. With the employment of the connecting grooves, the back plate and the frame can easily engage with each other when the frame is disposed on the back side of the back plate. In other words, the frame is connected to the back plate through the connecting grooves, so that the back plate and the frame are combined to form an integral frame with a concave center portion.

The lamp set is disposed on the concave center portion of the frame. The lamp racks engage with the frame to position the lamp set. The connecting groove of the back plate includes an inner sidewall, a top wall, and an outer sidewall. One end of the top wall connects to the inner sidewall, while the other end of the top wall connects to the outer sidewall which is opposite and parallel to the inner sidewall. That is, the top wall connects between the inner sidewall and the outer sidewall, so that the connecting groove of the back plate is an [symbol] (or reversed U) shape cross-section consisting of the inner sidewall, the top wall, and the outer sidewall. The configuration of the connecting groove corresponds to the frame to enhance the assembly speed and saving the labor cost.

The frame of the backlight module includes a first metal rack, a second metal rack, a third metal rack, and fourth metal rack. The second metal rack is parallel to the first metal rack. Two ends of the third metal rack include a connecting part, respectively. The third metal rack respectively connects to an end of the first metal rack and an end of the second metal rack through the connecting parts. Besides, the fourth metal rack is parallel to the third metal rack. Two ends of the fourth metal rack include a connecting part, respectively. The fourth metal rack respectively connects to an end of the first metal rack and an end of the second metal rack through the connecting parts.

The frame composed of the four metal racks is disposed on the back side of the back plate and combines with the back plate to form a backlight module base with enhanced rigidity.

### BRIEF DESCRIPTION OF THE DRAWINGS

FIG. 1 shows a schematic view of a conventional backlight module.

FIG. 2A shows a schematic view of a back plate in accordance with one embodiment of the present invention.

FIG. 2B shows a side view of a back plate in accordance with one embodiment of the present invention.

FIG. 3 shows an explosive view of a backlight module base in accordance with one embodiment of the present invention.

FIG. 4A shows an explosive view of a frame in accordance with one embodiment of the present invention.

FIG. 4B shows a side view of a frame in accordance with one embodiment of the present invention.

FIG. 4C shows a side view of a frame combined with a back plate in accordance with one embodiment of the present invention.

FIG. 4D shows a side view of a frame combined with a back plate in accordance with another embodiment of the present invention.

FIG. 5 shows a side view of a back plate assembled with a frame in accordance with one embodiment of the present invention.

FIG. 6 shows a schematic view of a backlight module in accordance with one embodiment of the present invention.

FIG. 7 shows a bottom view of a backlight module in accordance with one embodiment of the present invention.

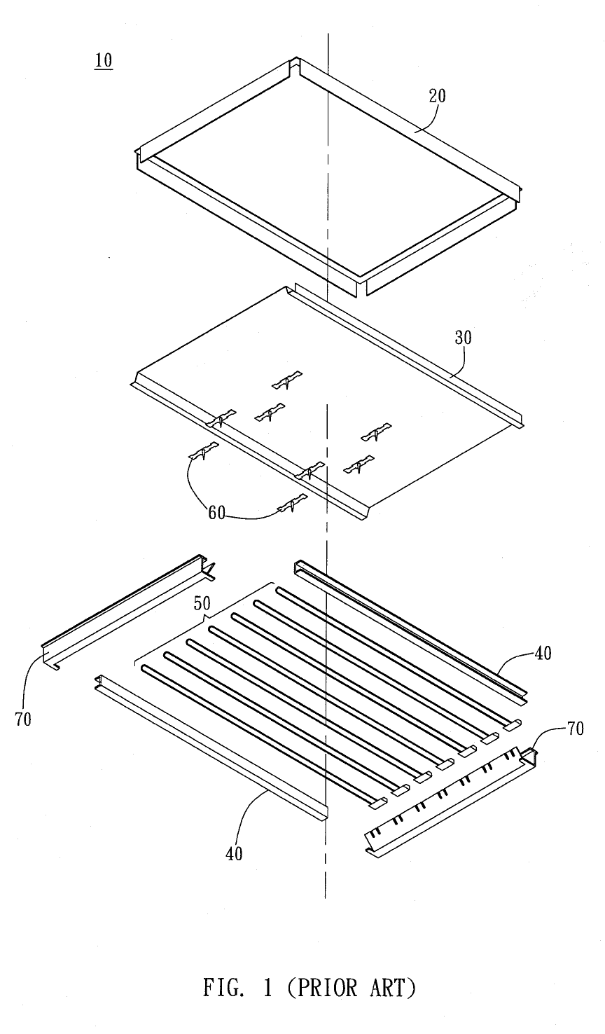

### DETAILED DESCRIPTION OF THE PREFERRED EMBODIMENT

The present invention provides a backlight module and an integral back plate thereof. In an embodiment, the backlight module is preferably used in a liquid crystal display (LCD). However, in other embodiments, the backlight module can be used for computer keyboards, mobile phone keyboards, panels or other flat displays. In another embodiment, the display panel implemented with the present invention can be a LCD panel. However, in other embodiments, the display panel implemented with the present invention can be a light-emitting diode (LED) display panel, an organic light-emitting diode (OLED) display panel, a polymer light-emitting diode (PLED) display panel, a monochrome LCD display panel, a cold cathode fluorescent lamp (CCFL) display panel, or an external electrode fluorescent lamp (EEFL) display panel. The display panel implemented with the present invention can be applied to a variety of display devices, flat display devices of household appliances, personal computers, and the laptops, and display devices of personal digital assistants (PDA), mobile phones, and digital cameras.

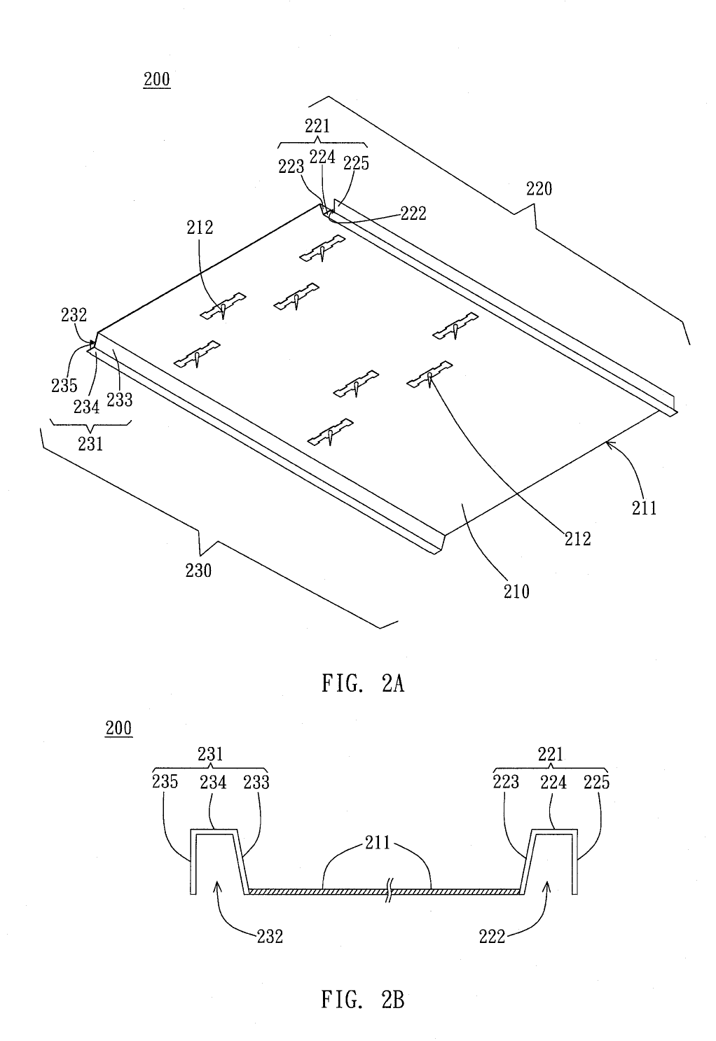

In the embodiment shown in FIG. 2A, the back plate 200 includes an inner surface 210, a first sidewall structure 220, and a second sidewall structure 230. The first sidewall structure 220 is disposed on one side of the inner surface 210 and bent to form a first connecting groove 221. The first connecting groove 221 has a first opening 222 disposed on the back side opposite to the inner surface 210. The second sidewall structure 230 is disposed on the inner surface 210 opposite to the first sidewall structure 220. Particularly, the second sidewall structure 230 is disposed on an opposite side corresponding to the first sidewall structure 220 and bent to form a second connecting groove 231. The second connecting groove 231 has a second opening 232 disposed on the back side opposite to the inner surface 210.

As shown in FIG. 2B, the inner surface of the back plate 200 forms a light reflecting surface 211. In such a design, the reflector is integrated into the back plate so as to eliminate the need of additional components and increase the structural space to cope with different designs and structures. Besides, in the embodiment, the back plate 200 is preferably composed of plastic materials and formed by a plastic injection-molding process. The light reflecting surface 211 is integrally formed on the back plate 200 by a process selected from the group consisting of a vapor deposition process, a pasting process, a coating process, a spray process, or a combination thereof. The material of the back plate 200 is selected from the group consisting of polycarbonate (PC), aromatic polycarbonate, block copolycarbonate, copolycarbonate, polyethylene terephthalate (PET), divinyl terephthalate, polyethylene (PE), polypropylene (PP), polystyrene (PS), polyvinyl chloride (PVC), low density polyethylene, acrylonitrile butadiene styrene (ABS), or a combination thereof.

In the embodiment shown in FIG. 2B, the first connecting groove 221 includes an inner sidewall 223, a top wall 224, and an outer sidewall 225. One end of the top wall 224 connects to the inner sidewall 223, while the other end of the top wall 224 connects to the outer sidewall 225. The outer sidewall 225 is approximately parallel to the inner sidewall 223, and the top wall 224 connects between the inner sidewall 223 and the outer sidewall 225. In other words, the first connecting groove 221 is formed as an [symbol] (or reversed U) shape cross-section consisting of the inner sidewall 223, the top wall 224, and the outer sidewall 225. The [symbol] (or reversed U) shape cross-section naturally includes the first opening 222. Thus, the second connecting groove 231 can be a similar [symbol] (or reversed U) shape cross-section consisting of an inner sidewall 233, a top wall 234, and an outer sidewall 235. Moreover, the second connecting groove 231 includes the second opening 232. In the embodiment shown in FIG. 2A, the first connecting groove 221, the second connecting groove 231, and the inner surface 210 are formed by a plastic injection-molding process. However, in other embodiments, the first connecting groove 221 and the second connecting groove 231 can be connected to the inner surface 210 by any suitable binding methods, such as engaging, screwing, welding, or adhering.

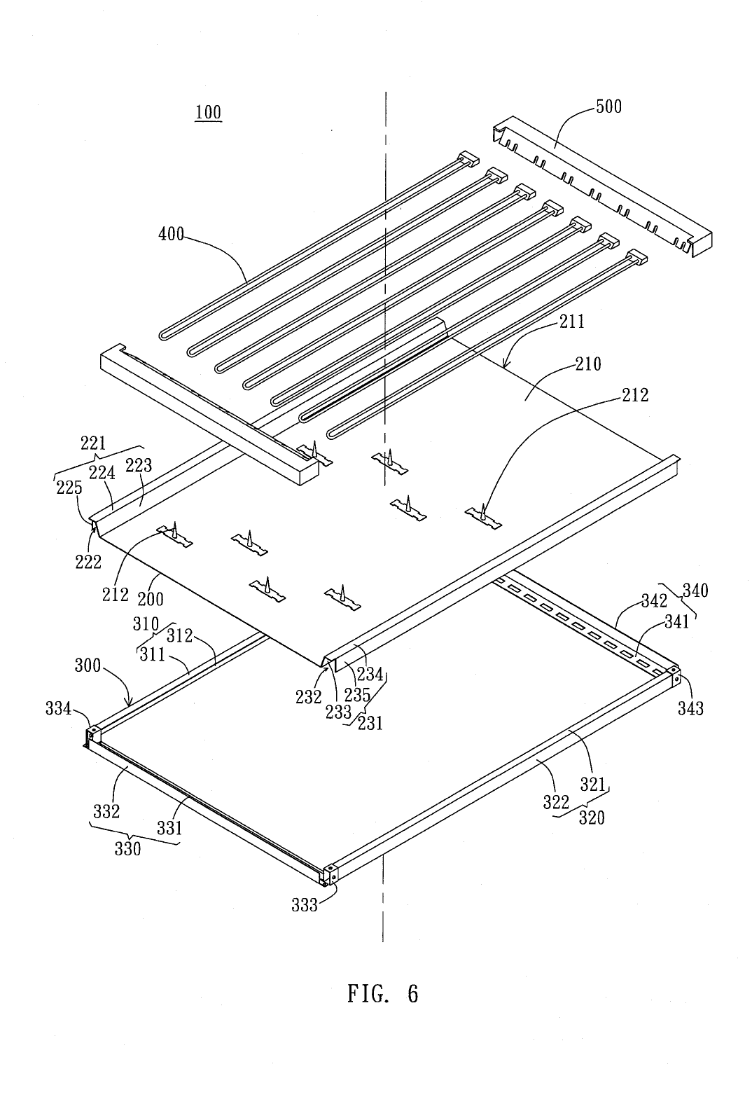

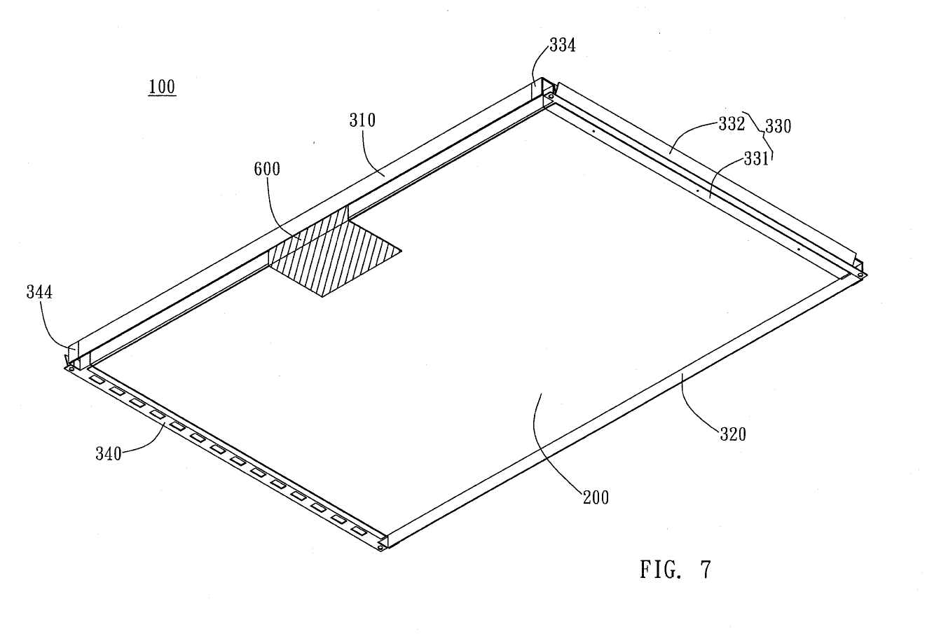

In the embodiment shown in FIG. 2A, on the inner surface 210 of the back plate 200, at least one lamp holder 212 is provided to support a lamp set 400 (see FIG. 6) and to define respective areas. As shown in FIG. 2A, the lamp holder 212 is preferably formed as a bump in a cone shape. However, in other embodiments, the lamp holder 212 can be formed as a bump in a shape of cylinder, pillar, semicircle, polygonal pillar, polygonal taper pillar, wedge, or semi-sphere. The lamp holder 212 preferably has the same material as the back plate 200. Preferably, the lamp holder 212 and the back plate 220 are integrally formed by a plastic injection-molding process. However, in other embodiments, the material of the lamp holder 212 can be different from the material of the back plate 200 and includes, but not limited to, polycarbonate (PC), aromatic polycarbonate, block copolycarbonate, copolycarbonate, polyethylene terephthalate (PET), divinyl terephthalate, polyethylene (PE), polypropylene (PP), polystyrene (PS), polyvinyl chloride (PVC), low density polyethylene (LDPE), acrylonitrile butadiene styrene (ABS), and a combination thereof.

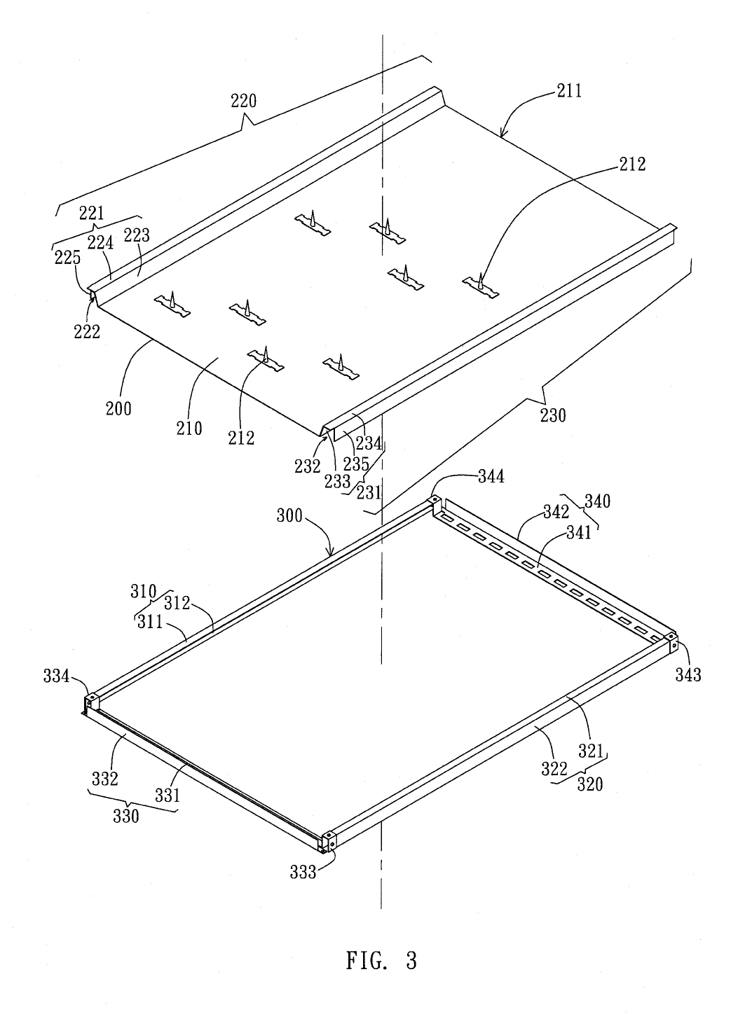

In the embodiment shown in FIG. 3, the present invention provides a backlight module base including the back plate 200 and a frame 300. The features of the back plate 200 are described in above embodiments. The frame 300 is disposed on the back side of the back plate 200 and combined with the back plate 200. That is, a first metal rack 310 and a second metal rack 320 of the frame 300 are inserted into the first connecting groove 221 and the second connecting groove 231 of the back plate 200 through the first opening 222 and the second opening 232 of the back plate 200, respectively. The distance between the first connecting groove 221 and the second connecting groove 231 of the back plate 200 is designed according to the size or the frame distance of the frame 300. The frame distance is the horizontal distance between the first metal rack 310 and the second metal rack 320. Without the first connecting groove 221 and the second connecting groove 231, the relative position of the frame 300 and the back plate 200 cannot be easily determined and therefore, the back plate 200 tends to shift with respect to the frame 300 whenever accidental vibrations occur.

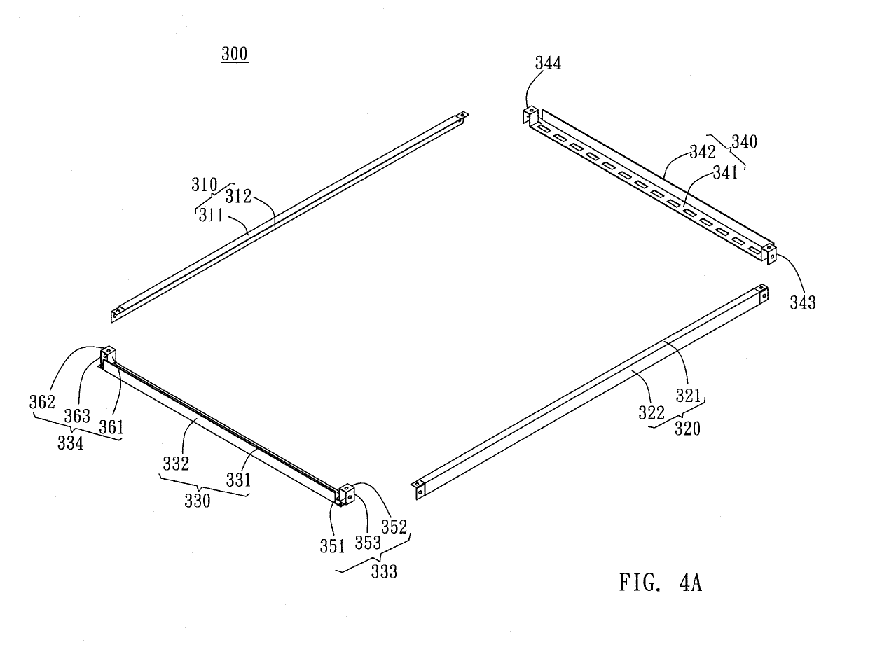

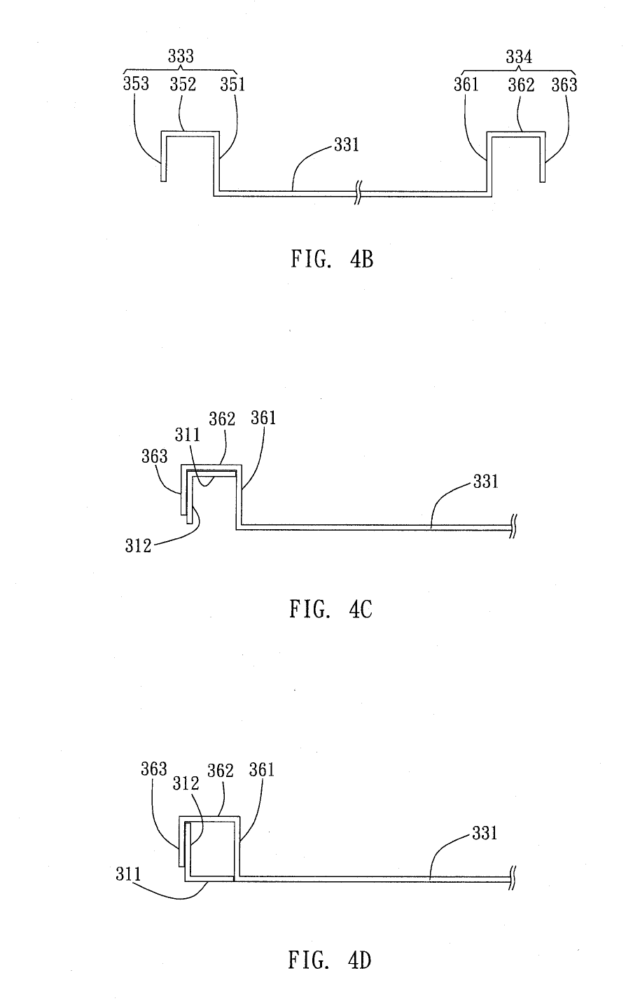

As shown in FIG. 4A, the frame 300 includes a first metal rack 310, a second metal rack 320, a third metal rack 330, and a fourth metal rack 340. The first metal rack 310 includes a first cross-section. In the embodiment, the first metal rack 310 includes a top plate 311 and a side plate together to form an L-shape cross-section. However, in other embodiments, the shape of the first cross-section can be, but not limited to, a square, a rectangle, a circle, a semi-circle, an oval shape, or any suitable geometrical shape.

In the embodiment shown in FIG. 4A, the second metal rack 320 is parallel to the first metal rack 310 and includes a top plate 321 and a side plate 322. The second metal rack 320 has a second cross-section. The shape of the second cross-section can be, but not limited to, an L-shape, a square, a rectangle, a circle, a semi-circle, an oval shape, or any suitable geometrical shape. In the embodiment, the shape of the first cross-section is similar to the shape of the second cross-section. However, in other embodiments, the first cross-section can be different from the second cross-section in accordance with different designs and demands. Furthermore, two ends of the third metal rack 330 respectively include a connecting part. The connecting parts connect an end of the first metal rack 310 and an end of the second metal rack 320, respectively. For example, as shown in FIG. 4A, the connecting parts include a first connecting part 333 and a second connecting part 334. Both the connecting parts have a structure for accommodating the first cross-section of the first metal rack 310 and the second cross-section of the second metal rack 320, respectively. In other words, the connecting parts 333 and 334 have a shape corresponding to the first cross-section and the second cross-section respectively. With reference to FIG. 4A, similarly, the fourth metal rack 340 includes a third connecting part 343 and a fourth connecting part 344 on a bottom plate 341. The shape of the third connecting part 343 is preferably corresponding to the second cross-section of the second metal rack 320, while the shape of the fourth connecting part 344 is preferably corresponding to the first cross-section of the first metal rack 310. The connecting parts and the metal racks can be connected by any suitable methods including, but not limited to, welding, screws, engaging, or adhering.

FIG. 4B shows a side view of the first connecting part 333 and the second connecting part 334, which are disposed on two ends of a bottom plate 331 of the third metal rack 330, instead of two ends of the side plate 332. However, in another embodiment, the arrangement of the connecting parts can be modified in accordance with different designs and required frame rigidity. The first connecting part 333 preferably includes a folding part having a first plate 351, a top plate 352, and a second plate 353. The first plate 351 is parallel to the second plate 353 and the top plate 352 connects the first plate 351 and the second plate 353. That is, two ends of the top plate 352 respectively connect to an end of the first plate 351 and an end of the second plate 353 so as to form a [symbol] (or reversed U) shape connecting part. Similarly, the second connecting part 334 includes a first plate 361, a top plate 362, and a second plate 363. The first plate 361, the top plate 362, and the second plate 363 together form a [symbol] (or reversed U) shape connecting part. However, in other embodiments, the second connecting part 334 can be modified in accordance with different designs and demands.

With reference to FIG. 4C, the third metal rack 330 has the top plate 362 connected to the top plate 311 of the first metal rack 310 and the second plate 363 connected to a side plate 312 of the first metal rack 310. The connection method thereof can be selected from the group consisting of welding, screwing, adhering, engaging, and so on. In a different embodiment shown in FIG. 4D, the first metal rack 310 connects with the second connecting part 334 through the second plate 363 and the side plate 312. The connection method thereof may include, but not limited to, welding, screws, engaging, and adhering. The second connecting part 334 and the first connecting part 333 have the same basic structure. However, the second connecting part 334 can be different from the first connecting part 333, but has to correspond to the second cross-section.

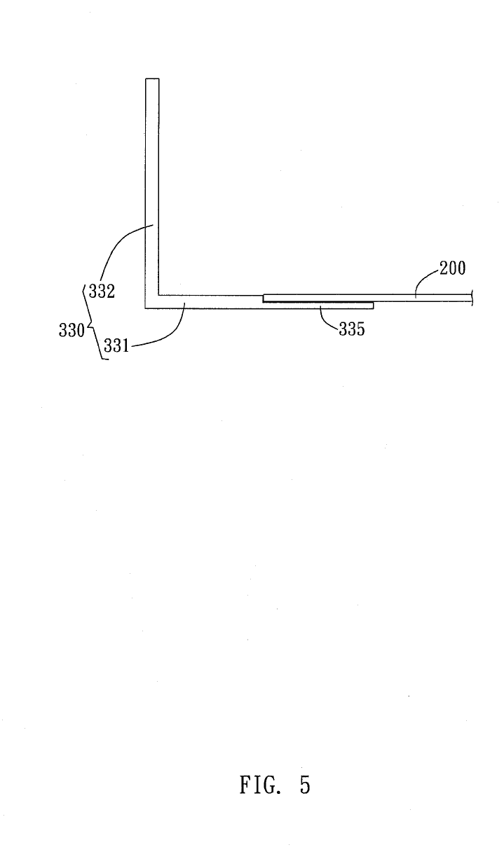

In another embodiment, as shown in FIG. 5, the third metal rack 330 includes the bottom plate 331 and the side plate 332 together to form an L-shape cross-section. The free end of the bottom plate 331 includes an indentation 335. The indentation 335 is provided to accommodate a lateral side of the back plate 200. When the lateral side of the back plate 200 engages with the indentation 335, an interface between the lateral side of the back plate 200 and the indentation 335 may include an L shape gap with a right angle. The L shape gap can prevent the dust from entering inside of the backlight module through where the back plate 200 and the bottom plate 331 of the third metal rack 330 are coupled so as to prolong the operating life of the backlight module.

In the embodiment shown in FIG. 6, the backlight module 100 of the present invention includes a back plate 200, a frame 300, a lamp set 400, and a lamp rack 500. The back plate 200 and the frame 300 can be assembled to form the above-mentioned backlight module base having a concave center portion. In such a design, the frame 300 supports the back plate 200 to enhance the rigidity of the backlight module. Besides, the back plate 200 preferably integrates a reflector and a plastic frame to be an integral back plate 200. In the embodiment of the present invention, the lamp holder 212 in cooperation with the lamp rack 500 can define the location of the lamp set 400. However, in other embodiment, the lamp rack 500 can independently fix the lamp set 400 without any contribution of the lamp holder 212. The lamp rack 500 respectively connects with the third metal rack 330 and the fourth metal rack 340 to fix the lamp set 400 in the concave center portion. The connection method includes, but not limited to, engaging, welding, screws, or adhering.

As shown in FIG. 7, the backlight module 100 of the present invention further includes a metal cover 600, which can shield the module from being interfered by electromagnetic wave. In the embodiment shown in FIG. 7, the metal cover 600 engages with the first metal rack 310 from the back side of the above-mentioned backlight module base. The connection method includes, but not limited to, welding, screws, engaging, or adhering. However, in other embodiments, the metal cover 600 can respectively engages with the second metal rack 320, the third metal rack 330, or the fourth metal rack 340 by any suitable connection method so as to achieve the backlight module 100 having same functions but using less materials. Furthermore, the lamp set 400 of the present invention may have lamps including, but not limited to, CCFL, EEFL, or LED.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A back plate for a backlight module of a liquid crystal display device, the back plate comprising:
an inner surface;
a first sidewall structure, disposed on one side of the inner surface, wherein the first sidewall structure is bent to form a first connecting groove, and a first opening of the first connecting groove is on a back side opposite to the inner surface; and
a second sidewall structure, disposed on a corresponding side opposite to the first sidewall structure, wherein the second sidewall structure is bent to form a second connecting groove, and a second opening of the second connecting groove is on the back side opposite to the inner surface.

2. The back plate of claim 1, wherein a material of the back plate is selected from the group consisting of polycarbonate (PC), aromatic polycarbonate, block copolycarbonate, copolycarbonate, polyethylene terephthalate (PET), divinyl terephthalate, polyethylene (PE), polypropylene (PP), polystyrene (PS), polyvinyl chloride (PVC), low density polyethylene (LDPE), acrylonitrile butadiene styrene (ABS), and a combination thereof.

3. The back plate of claim 1, wherein the back plate is formed by a plastic injection-molding process.

4. The back plate of claim 1, wherein the inner surface is a light reflecting surface.

5. The back plate of claim 4, wherein the light reflecting surface is integrally formed on the back plate by a process selected from the group consisting of a vapor deposition process, a pasting process, a coating process, a spray process, or a combination thereof.

6. The back plate of claim 1, wherein the first connecting groove includes:
an inner sidewall;
a top wall, one end of the top wall connecting to the inner sidewall; and
an outer sidewall, connecting to one end of the top wall opposite to the inner sidewall, wherein the outer sidewall is parallel to the inner sidewall, and the top wall connects between the inner sidewall and the outer sidewall.

7. The back plate of claim 1, wherein the inner surface includes at least one lamp holder.

8. The back plate of claim 7, wherein the lamp holder is formed as a bump in a shape of cylinder, cone, pillar, semicircle, polygonal pillar, polygonal taper pillar, wedge, semi-sphere, or a combination thereof.

9. A backlight module base for a display device, the backlight module base comprising:
a back plate having an inner surface and two sidewall structures on two opposite sides of the back plate, wherein each of the sidewall structure is bent to form a connecting groove, an opening of the connecting groove is on a back side opposite to the inner surface; and
a frame disposed on the back side of the back plate and received in the connecting groove through the opening.

10. The backlight module base of claim 9, wherein a material of the back plate is selected from the group consisting of polycarbonate (PC), aromatic polycarbonate, block copolycarbonate, copolycarbonate, polyethylene terephthalate (PET), divinyl terephthalate, polyethylene (PE), polypropylene (PP), polystyrene (PS), polyvinyl chloride (PVC), low density polyethylene, acrylonitrile butadiene styrene (ABS), and a combination thereof.

11. The backlight module base of claim 9, wherein the back plate is formed by a plastic injection-molding process.

12. The backlight module base of claim 9, wherein the inner surface is a light reflecting surface.

13. The backlight module base of claim 12, wherein the light reflecting surface is integrally formed on the back plate by a process selected from the group consisting of a vapor deposition process, a pasting process, a coating process, a spray process, and a combination thereof.

14. The backlight module base of claim 9, wherein the connecting groove includes:
an inner sidewall;
a top wall, one end of the top wall connecting to the inner sidewall; and
an outer sidewall, connecting to one end of the top wall opposite to the inner sidewall, wherein the outer sidewall is parallel to the inner sidewall, and the top wall connects between the inner sidewall and the outer sidewall.

15. The backlight module base of claim 9, wherein the inner surface includes at least one lamp holder.

16. The backlight module base of claim 15, wherein the lamp holder is formed as a bump in a shape of cylinder, cone, pillar, semicircle, polygonal pillar, polygonal taper pillar, wedge, semi-sphere, or a combination thereof.

17. The backlight module base of claim 9, wherein the frame comprises:
a first metal rack having a first cross-section;
a second metal rack having a second cross-section and being parallel to the first metal rack;
a third metal rack, wherein two ends of the third metal rack respectively includes a connecting part, the third metal rack respectively connects to an end of the first metal rack and an end of the second metal rack through the connecting parts, each of the connecting parts has a corresponding structure to accommodate the first cross-section or the second cross-section; and
a fourth metal rack parallel to the third metal rack, wherein two ends of the fourth metal rack respectively includes a connecting part, the fourth metal rack respectively connects to an end of the first metal rack and an end of the second metal rack through the connecting parts, each of the connecting parts has a corresponding structure to accommodate the first cross-section or the second cross-section.

18. The backlight module base of claim 17, wherein the third metal rack includes a bottom plate and a side plate combined to form an L-shape cross-section, a free end of the bottom plate includes an indentation, the indentation accommodates a lateral side of the back plate.

19. The backlight module base of claim 17, wherein the first metal rack includes a top plate and a side plate combined to form an L-shape cross-section.

20. The backlight module base of claim 19, wherein the connecting part of the third metal rack connecting to the first metal rack includes a folding part having a first plate, a top plate, and a second plate, the first plate is parallel to the second plate, the top plate connects between the first plate and the second plate, two ends of the top plate respectively connect to an end of the first plate and an end of the second plate, the top plate of the third metal rack connects with the top plate of the first metal rack, while the second plate connects with the side plate of the first metal rack.

21. A backlight module, comprising:
a back plate including an inner surface and two sidewall structures on two opposite sides of the back plate respectively, wherein each of the sidewall structures is bent to form a first connecting groove, an opening of the connecting groove is on a back side opposite to the inner surface;
a frame disposed on the back side of the back plate and received in the connecting groove through the opening so that the back plate and the frame are combined to form a frame with a concave center portion;
a lamp set disposed on the concave center portion of the frame; and
a lamp rack engaging with the frame to fix the lamp set.

22. The backlight module of claim 21, wherein a material of the back plate is selected from the group consisting of polycarbonate (PC), aromatic polycarbonate, block copolycarbonate, copolycarbonate, polyethylene terephthalate (PET), divinyl terephthalate, polyethylene (PE), polypropylene (PP), polystyrene (PS), polyvinyl chloride (PVC), low density polyethylene, acrylonitrile butadiene styrene (ABS), and a combination thereof.

23. The backlight module of claim 21, wherein the back plate is formed by a plastic injection-molding process.

24. The backlight module of claim 21, wherein the inner surface is a light reflecting surface.

25. The backlight module of claim 24, wherein the light reflecting surface is integrally formed on the back plate by a process selected from the group consisting of a vapor deposition process, a pasting process, a coating process, a spray process, and a combination thereof.

26. The backlight module of claim 21, wherein the connecting groove includes:
an inner sidewall;
a top wall, one end of the top wall connecting to the inner sidewall; and
an outer sidewall, connecting to one end of the top wall opposite to the inner sidewall, wherein the outer sidewall is parallel to the inner sidewall, and the top wall connects between the inner sidewall and the outer sidewall.

27. The backlight module of claim 21, wherein the inner surface includes at least one lamp holder.

28. The backlight module of claim 27, wherein the lamp holder is formed as a bump in a shape of cylinder, cone, pillar, semicircle, polygonal pillar, polygonal taper pillar, wedge, semi-sphere, or a combination thereof.

29. The backlight module of claim 21, wherein the frame base comprises:
a first metal rack having a first cross-section;
a second metal rack having a second cross-section and being parallel to the first metal rack;
a third metal rack, wherein two ends of the third metal rack respectively includes a connecting part, the third metal rack respectively connects to an end of the first metal rack and an end of the second metal rack through the connecting parts, each of the connecting parts has a corresponding structure to accommodate the first cross-section or the second cross-section; and
a fourth metal rack parallel to the third metal rack, wherein two ends of the fourth metal rack respectively includes a connecting part, the fourth metal rack respectively connects to an end of the first metal rack and an end of the second metal rack through the connecting parts, each of the connecting parts has a corresponding structure to accommodate the first cross-section or the second cross-section.

30. The backlight module of claim 29, wherein the lamp rack respectively connects with the third metal rack and the fourth metal rack by welding, screwing, engaging, or adhering.

31. The backlight module of claim 29, further comprising a metal cover, wherein the metal cover connects with the first metal rack by welding, screwing, engaging, or adhering.

32. The backlight module of claim 29, wherein the third metal rack includes a bottom plate and a side plate combined to form an L-shape cross-section, a free end of the bottom plate includes an indentation, the indentation accommodates a lateral side of the back plate.

33. The backlight module of claim 29, wherein the first metal rack includes a top plate and a side plate combined to form an L-shape cross-section.

34. The backlight module of claim 33, wherein the connecting part of the third metal rack connecting to the first metal rack includes a folding part having a first plate, a top plate, and a second plate, the first plate is parallel to the second plate, the top plate connects between the first plate and the second plate, two ends of the top plate respectively connect to an end of the first plate and an end of the second plate, the top plate of the third metal rack connects with the top plate of the first metal rack, while the second plate connects with the side plate of the first metal rack.
